(19) United States
(12) Patent Application Publication
(10) Pub. No.: US 2010/0260017 A1
(43) Pub. Date: Oct. 14, 2010

(54) Method and Apparatus for Capturing Encoded Signals on Label Surface

(75) Inventors: Wei-Ting Huang, Guishan Shiang (TW); Chun-Wen Lai, Guishan Shiang (TW); Chi-Hsiang Kuo, Guishan Shiang (TW); Shih-Jung Huang, Guishan Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: QUANTA STORAGE INC., Guishan Shiang (TW)

(21) Appl. No.: 12/617,960

(22) Filed: Nov. 13, 2009

(30) Foreign Application Priority Data
Apr. 10, 2009 (TW) 098112250

(51) Int. Cl. G11B 7/00

(52) U.S. Cl. 369/44.11; G9B/7

(57) ABSTRACT

A method and an apparatus for capturing encoded signals on a label surface. A pick-up head is utilized to detect all or predetermined codes on a control feature zone of a label surface of a Light Scribe disc so as to generate a sub-beam added signal. A calculation unit is used to calculate the average value of the sub-beam added signals. A dynamic slicer, which could dynamically set its standard value at a half of the average value of the sub-beam added signals, slices the sub-beam added signals and captures the encoded signals. A processor decodes the encoded signals and translates those into Light Scribe disc's information.

### BACKGROUND

1. Field of the Invention

The present invention relates to a method and an apparatus for capturing signals on a label surface of a Light Scribe disc. More particularly, the present invention relates to a method and an apparatus for using a slicer, wherein the slicer of the optical disc drive captures encoded signals reflected from a control feature zone, which is at the inner annular section of a label surface. According to variation of sub-beam added signals reflected from the control feature zone thus can capture signals on the label surface.

2. Description of Related Art

A conventional optical disc has two sides, namely a data side and a label side, wherein a label is provided on the label side for identification purposes. The most common way to identify the label side is marking it with a pen or a label sticker. Recently, with a view to improve enhanced aesthetics and personalization, the Light Scribe labeling technique was developed. By etching the label side of a Light Scribe disc with laser beam emitted by the pick-up head of the optical disc drive, so as to form the desired patterns or words on the label side. More specifically, the label side has a control feature zone, which is located at an inner annular section of the label side, and a plurality of spokes are evenly distributed and equiangular arranged on the inner periphery of the control feature zone. While detecting and identifying the spokes could provide a reference indicia for positioning the pick-up head. Thus, the pick-up head could scribe the label surface and ensure that the patterns or the words to accurately etch on the label side. The control feature zone contains encoded signals that provide information of the Light Scribe disc, such as identification information of the Light Scribe disc, etc.

The conventional optical disc drive's method or apparatus for capturing encoded signals from a control feature zone at the inner annular section of a label surface works in the following manner. A pick-up head of the optical disc drive projects a laser beam on the control feature zone, by receiving light reflected from the control feature zone's code, and then converts the reflected light, by means of an amplifier, into the sub-beam added signals, which is a radio frequency (RF) signals. Traditionally, the prior art would read the sub-beam added signals in following manner. First, compares the reflection amount of the sub-beam added signals with a fixed slicer set as a standard value. Then, if those sub-beam added signals are higher than the standard value, those signals will be determined as digital high signals, otherwise will be determined as digital low signals. Thus, the encoded signals which are contained in the control feature zone at the inner annular section of the label surface could successfully read.

However, the Light Scribe disc's label side has relative low reflectivity than the data side. Thus the reflection of the sub-beam added signals detected from the label side are less than those detected from the data side. Moreover, an incorrect gain setting of the pick-up head often leads to signal misinterpretation. For example, FIG. 1 and FIG. 2 illustrate two cases of signal misinterpretation in the prior art. As shown in FIG. 1, if the amplifier gain is set improperly, or if sub-beam added signals 11 are shifted would cause the sub-beam added signals 11 entered an upwardly saturation stage, which value lie generally above the standard value 12 of a fixed slicer, and it is very likely that the sub-beam added signals 11 will be mistaken as digital high signals. As a result, wrong encoding signals 13 are read. By contrast, referring to FIG. 2, if a pick-up head is set with an improper amplifier gain value or the sub-beam added signals 14 are shifted would cause the sub-beam added signals 14 entered a downwardly saturation stage, which value lie generally below the predetermined standard value 12 of a fixed slicer. In this case, the sub-beam added signals 14 will be determined as digital low signals, and a wrong encoding signal 15 will be read. Hence, due to the aforesaid drawbacks, by using a fixed standard value 12 of the fixed slicer to capture signals from a control feature zone at an inner annular section of a label surface of a Light Scribe disc are prone to be easily mistaken. In consequence, desired patterns or words on the label side may distort and twist, furthermore couldn't be written anymore. Therefore, the conventional method and apparatus for capturing encoded signals from a control feature zone at an inner annular section of a label surface of a Light Scribe disc still leave much room for improvement.

### BRIEF SUMMARY OF THE INVENTION

An objective of the present invention is to provide a method for capturing encoded signals on a disc's label side, wherein a standard value of the slicer is dynamically set according to the average value of sub-beam added signals which reflected from codes in a control feature zone at an inner annular section of the label side, so as to ensure that encoded signals in the control feature zone are accurately read.

Another objective of the present invention is to provide a method for capturing encoded signals on a label side, wherein a standard value of the slicer is determined dynamically by the average value of the predetermined sub-beam added signals generated from the control feature zones at an inner annular section of the label side, so as to accurately capture encoded signals from the control feature zones.

To achieve the aforesaid objectives, the present invention provides a method for capturing encoded signals on a label side, wherein the method includes the steps of: emitting a laser beam on the label side's inner annular surface; detecting the sub-beam added signal generated from all or predetermined codes on the control feature zone, which lies on the inner annular section of the label surface; calculating the average value of the sub-beam signals; setting a standard dividing value at the half of the average value; dividing the amount of reflected signals and capturing the encoded signals; and translating the encoded signals on the control feature zone into readable information.

Another objective of the present invention is to provide an apparatus for capturing encoded signals on a label side of a disc and the apparatus further includes a calculation unit. The calculation unit could calculate the average value of the sub-beam added signals, and the standard value of the dynamic slicer is set at the half of the average value of the sub-beam signals, so as to capture encoded signals accurately.

To achieve the above objective, the present invention provides an apparatus for capturing encoded signals on a label side, which includes a pick-up head that would emit a laser beam on a label side of a Light Scribe disc. The laser beam will be partly reflected when it hits the code on the control feature zone, the reflection would be received and transferred into the sub-beam added signals. And the calculation unit would calculate the average value of the sub-beam added signals. The present invention further includes a dynamic slicer, whose standard dividing value is set at a half of the average value of the sub-beam added signals. With the standard dividing value, the sub-beam signals could be referred as to either high or low digital signals. And the processor could translate the encoded signals and outputs the information written in the Light Scribe disc.

### BRIEF DESCRIPTION OF THE SEVERAL VIEWS OF THE DRAWINGS

The technical means adopted by the present invention to achieve the above and other objects can be best understood by referring to the following detailed description of the preferred embodiments and the accompanying drawings, in which:

FIG. 1 schematically illustrates an upwardly saturated signal in the prior art;

FIG. 2 schematically illustrates a downwardly saturated signal in the prior art;

FIG. 3 is a function block diagram of the capturing apparatus for the encoded signals of the present invention;

FIG. 4 is a schematic drawing showing a process of capturing encoded signals according to the first embodiment of the present invention;

FIG. 5 is a flowchart of a method for capturing encoded signals according to the first embodiment of the present invention;

FIG. 6 is a schematic drawing showing a process of capturing encoded signals according to the second embodiment of the present invention; and

FIG. 7 is a flowchart of a method for capturing encoded signals according to the second embodiment of the present invention.

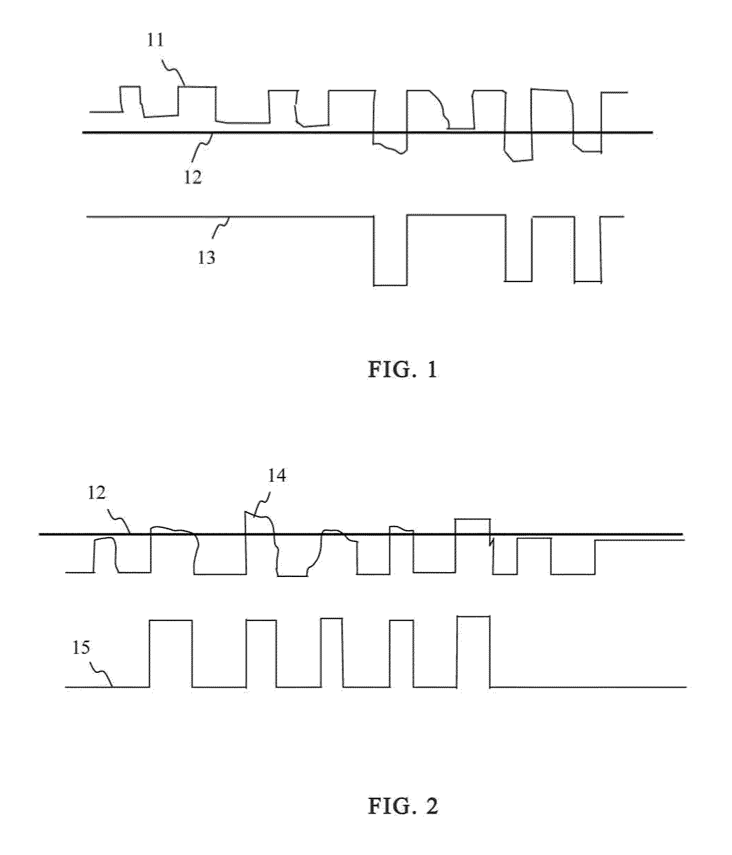

### DETAILED DESCRIPTION OF THE INVENTION

An exemplary embodiment of present invention will hereinafter be described in detail with reference to the accompanying drawing. As those skilled in the art would realize, the described embodiments may be modified in various different ways, all without departing from the spirit or scope of the present invention.

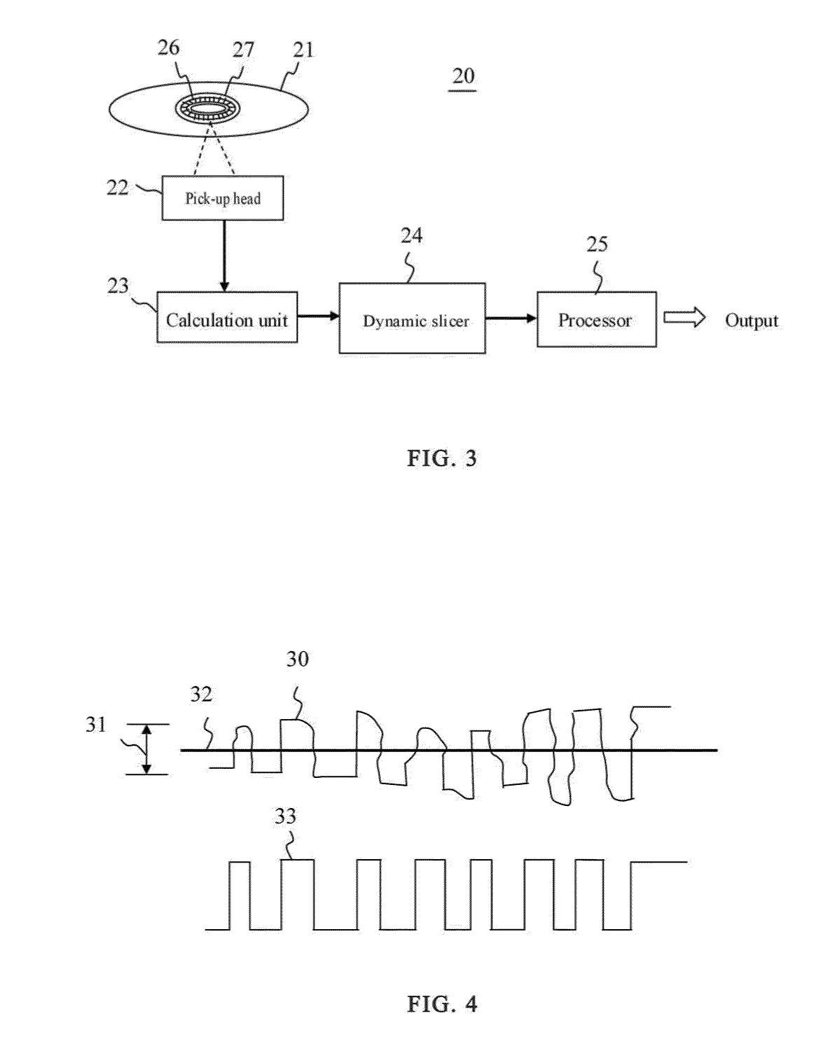

Referring to FIG. 3, FIG. 3 is a function block diagram of the capturing apparatus for the encoded signals of the present invention. The present invention includes a capturing apparatus 20 which could capture the encoded signals on a label side and is provided in an optical disc drive. The capturing apparatus 20 comprises a Light Scribe disc 21, a pick-up head 22, a calculation unit 23, a dynamic slicer 24 and a processor 25. The pick-up head 22 would emit a laser beam on the inner annular section of a label side of the Light Scribe disc 21, and the inner annular section of the label side further includes a spoke zone 26 and a control feature zone 27. The pick-up head 22 receives laser's reflections, which reflects by codes on the control feature zone 27, and the reflections will be converts into sub-beam added signals 30 (as shown in FIG. 4). The sub-beam added signals 30 are in the form of RF signals. Input the sub-beam added signals 30 into the calculation unit 23. And the calculation unit 23 would calculate the average value of the sub-beam added signals 30. The standard dividing value of the dynamic slicer 24 is sets at the half of the average value of the sub-beam signals 24. In this way, the standard dividing value of the dynamic slicer 24 would changes dynamically with the sub-beam signals 30 and maintains at the half of the sub-beam signals. Then according to the standard dividing value of the dynamic slicer 24 then processes the sub-beam signals 30 into rather digital high or digital low signals. After the processor 25 processes the sub-beam signals 30, the information on the control feature zone 27 at the inner annular section of the label surface of the Light Scribe disc 21 would be correctly read. Finally, information of the Light Scribe disc 21 would be output to a host (not shown) for further operation.

Please refer to FIG. 3 and FIG. 4. FIG. 4 is a schematically shows a process of capturing encoded signals on a label side according to a first embodiment of the present invention. After the pick-up head 22 receives the sub-beam added signals 30 reflected from the codes on the control feature zone 27. Then input the sub-beam added signals 30 into the calculation unit 23 to calculate the peak values and the valley values of the sub-beam added signals 30 and record the magnitudes of the sub-beam added signals 30. While the Light Scribe disc 21 finish a full rotation, the average value 31 of the sub-beam added signals 30 could be calculates. Then, the standard value 32 of the dynamic slicer 24 is dynamically set at a half of the average value 31 of the sub-beam added signals 30. After the standard value 32 is set, the dynamic slicer 24 compares the sub-beam added signals 30 with the standard value 32 and for those sub-beam added signals 30 which are higher than the standard value 32 of the dynamic slicer 24 would be determined as a digital high signals, and for those sub-beam added signals 30 which are lower would be determined as a digital low signals. The encoding signals 33, which have been processed by the dynamic slicer 24, will be input into the processor 25 and will be correctly decoded to the information contained in the control feature zone 27 at the inner annular section of the label surface of the Light Scribe disc 21.

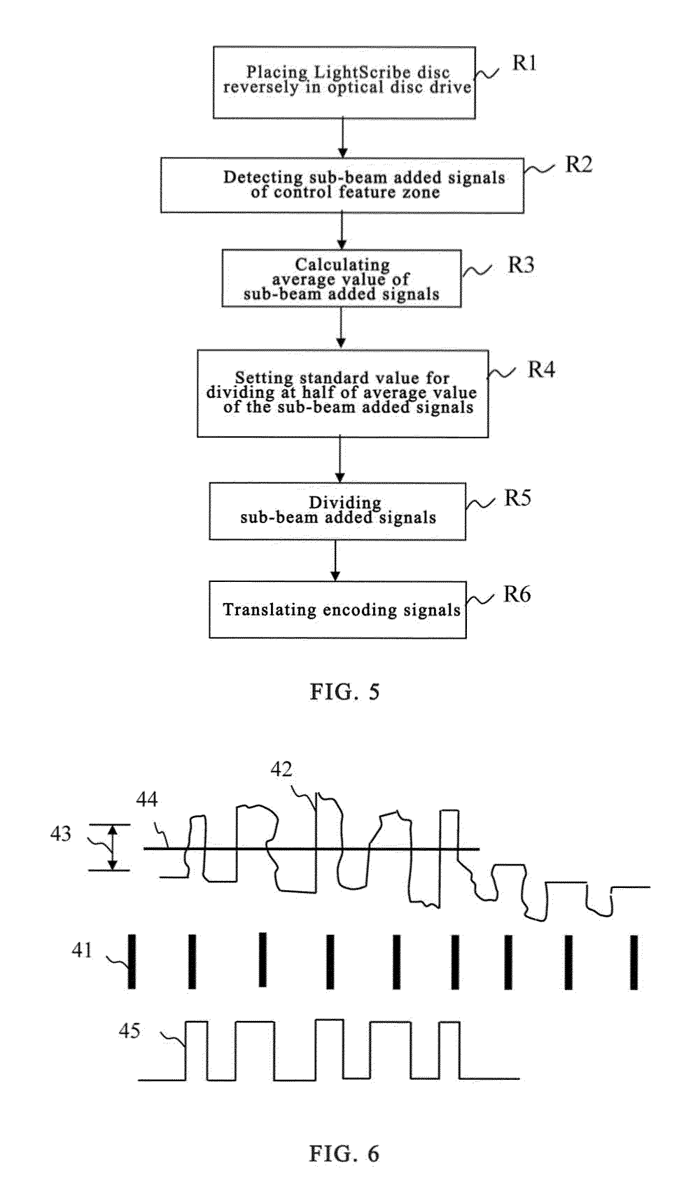

FIG. 5 is a flowchart of a method for capturing encoding signals on a label surface according to the first embodiment of the present invention. In the present embodiment, the standard value 32 of the dynamic slicer 24 is dynamically set in order to correctly capture encoded signals from the control feature zone 27 at an inner annular section of a label surface of a Light Scribe disc. More specifically, the method includes the following steps. At step R1, a Light Scribe disc is placed reversely in an optical disc drive such that a label surface of the Light Scribe disc could face the pick-up head 22. At step R2, the pick-up head 22 projects a laser beam on the control feature zone 27 at an inner annular section of the Light Scribe disc so as to obtain sub-beam added signals 30. At step R3, the sub-beam added signals 30 are input into a calculation unit 23, which then calculates the average value of the sub-beam added signals 30. At step R4, the standard value of a dynamic slicer 24 is dynamically set at a half of the average value of the sub-beam added signals 30. Step R5, the dynamic slicer 24 processes and divide (i.e., slices) the sub-beam added signals 30. At step R6, the encoded signals are input into the processor 25 so as to decode the information contained in the control feature zone 27 at the inner annular section of the label surface of the Light Scribe disc.

In short, in the method and apparatus for capturing encoded signals on a label side according to the first embodiment of the present invention, the calculation unit 23 is configured for calculating the average value of the sub-beam added signals 30 reflected from the codes on the control feature zone 27 at an inner annular section of the label surface, and the standard value 32 of the dynamic slicer 24 is dynamically set at a half of the average value of the sub-beam added signals 30, thereby ensuring that the encoded signals of the control feature zone 27 at the inner annular section of the label surface can be captured correctly.

Please refer to FIG. 6 for a process of capturing encoded signals on a label side according to a second embodiment of the present invention. As previously mentioned, the label side of a Light Scribe disc has an inner annular section including a control feature zone 27 and a spoke zone 26. The control feature zone 27 is formed with a plurality of zigzag and block-shaped encoding structures and includes high-reflection regions and low-reflection regions. Furthermore, codes in the control feature zone 27 at the inner annular section of the label side of the Light Scribe disc are arranged in correspondence with spokes 41 in the spoke zone 26. In the second embodiment, the sub-beam added signals 42 are collected from the codes that correspond to predetermined spokes 41. Then, the average value 43 of the sub-beam added signals 42 is calculated. The standard value 44 of a dynamic slicer 24 is dynamically set at a half of the average value 43, such that the standard value 44 shifts dynamically with the average value 43 of the sub-beam added signals 42 corresponding to the predetermined spokes 41. Thus, the standard value 44 is maintained at the half of the sub-beam added signals 42. This may also prevented the standard value 44 from shifting. Consequently, the sub-beam added signals 42 can be divided with enhanced precision, thereby allowing encoded signals 45 of the control feature zone 27 at the inner annular section of the label side of the Light Scribe disc to be translated correctly.

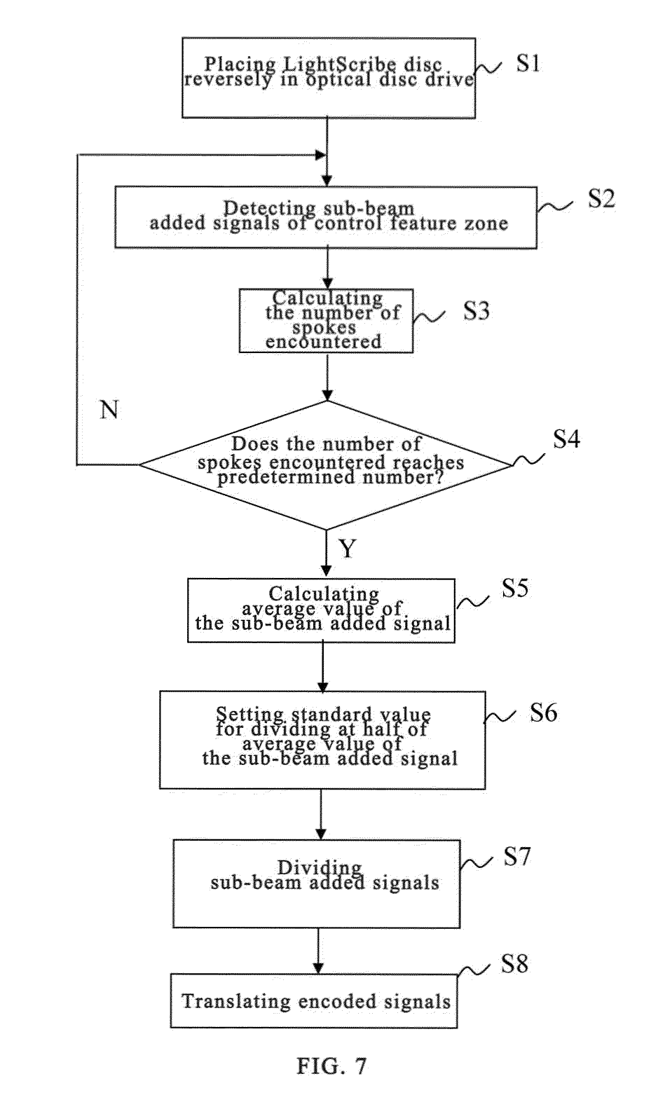

FIG. 7 shows a flowchart of a method for capturing encoded signals on a label side according to the second embodiment of the present invention. In the second embodiment, the standard value 44 of a dynamic slicer 24 is dynamically set in order to correctly capture encoded signal from predetermined control feature zone 27 at an inner annular section of a label side of a Light Scribe disc. More specifically, the method includes the following steps. At step S1, a Light Scribe disc is placed reversely in an optical disc drive such that the label side of the Light Scribe disc could face the pick-up head 22. At step S2, the pick-up head 22 projects a laser beam on the control feature zone 27 at an inner annular section of the Light Scribe disc so as to obtain sub-beam added signals 42. At step S3, calculates the number of spokes 41 encountered by the pick-up head 22. At step S4, if the number of the encountered spokes 41 reaches to a predetermined number, then go to the next step. If not, the process goes back to step S2. At step S5, the predetermined number of sub-beam added signals 42 obtained are input into the calculation unit 23 so as to calculate the average value 43 of the sub-beam added signals 42. At step S6, the standard value 44 of a dynamic slicer 24 is dynamically set at a half of the average value 43 of the sub-beam added signals 42. At step S7, the dynamic slicer 24 processes and divides (i.e., slices) the sub-beam added signals 42. At step S8, the encoded signals are translated by the processor 25 into information contained in the control feature zone 27 at the inner annular section of the label surface of the Light Scribe disc.

In short, in the method for capturing encoded signals on a label side according to the second embodiment of the present invention, the number of spokes encountered is calculated until a predetermined number is reached. Then, the average value of sub-beam added signals is obtained. The standard value of the dynamic slicer is dynamically set at the half of the sub-beam added signals reflected form the predetermined codes. Thus, encoded signals of the control feature zone at the inner annular section of the label surface can be captured accurately.

The present invention has been demonstrated herein by reference to the preferred embodiments. However, it is understood that the embodiments are not intended to limit the scope of the present invention, which is defined only by the appended claims. Therefore, any changes or modifications that are based on the contents disclosed herein and do not depart from the spirit of the present invention should be encompassed by the appended claims.

What is claimed is:

1. A method for capturing encoded signals on a label side of a Light Scribe disc, comprising steps of:
(1) emitting a laser beam to codes on a control feature zone at an inner annular section of the label side of a Light Scribe disc and reflecting sub-beam added signals;
(2) calculating the average value of the sub-beam added signals;
(3) setting a slicer's dividing standard value at a half of the average value of the sub-beam added signals;
(4) dividing the sub-beam added signals and capturing encoded signals in the control feature zone; and
(5) translating the encoding signals.

2. The method of capturing encoded signals on a label side of a Light Scribe disc according to claim 1, wherein the step (4) further comprises a reference indicia, which determines the sub-beam added signals, if the sub-beam added signal is higher than the dividing standard value will be referred as digital high signal, and if the sub-beam added signal is lower than the dividing standard value will be referred as digital low signal.

3. The method of capturing encoded signals on a label side of a Light Scribe disc according to claim 1, wherein the step (5) further comprises translating the encoding signals into information that contained in the control feature zone at the inner annular section of the label side.

4. A method for capturing encoding signals on a label side, comprising steps of:
(1) emitting a laser beam to codes on a control feature zone at an inner annular section of the label side of a Light Scribe disc and reflecting sub-beam added signals;
(2) calculating the number of spokes encountered during the operating;
(3) returning to the step (1) to detect more spokes if the number of the spokes encountered does not reach a predetermined number, and proceeding to step (4) if the number of the spokes encountered reaches the predetermined number;
(4) calculating an average value of the sub-beam added signals;
(5) setting a dividing standard value at a half of the average value of the sub-beam added signals;
(6) dividing the sub-beam added signals and capturing encoded signals; and
(7) translating the encoding signals.

5. The method of capturing encoded signals on a label side of a Light Scribe disc according to claim 4, wherein the step (6) further comprises a reference indicia, which determines the sub-beam added signals, if the sub-beam added signals are higher than the dividing standard value will be referred as digital high signals, and if the sub-beam added signals are lower will be referred as digital low signals.

6. The method of capturing encoded signals on a label side of a Light Scribe disc according to claim 4, wherein the step (7) further. comprises translating the encoding signals into information that contained in the control feature zone at the inner annular section of the label surface.

7. An apparatus for capturing encoded signals on a label side, which is provided in an optical disc drive, comprising:
a pick-up head for projecting a laser beam on a label side of a Light Scribe disc and receiving light reflected by codes on a control feature zone of the label side, which referred as a sub-beam added signal;
a calculation unit for calculating the average value of the sub-beam added signals;
a dynamic slicer whose standard value for dividing is set dynamically at a half of the average value of the sub-beam added signals and which is configured for dividing the sub-beam added signals into digital high signals and digital low signals; and
a processor for translating the encoded signals.

8. The apparatus for capturing encoded signals on a label side according to claim 7, wherein the codes of the control feature zone consist of all codes in the control feature zone.

9. The apparatus for capturing encoded signals on a label side according to claim 7, wherein the codes of the control feature zone consist of predetermined codes in the control feature zone.

10. The apparatus for capturing encoded signals on a label side according to claim 7, wherein the encoded signals of the control feature zone are translated into information of the Light Scribe disc.
